(19) United States
(12) Patent Application Publication
(10) Pub. No.: US 2019/0158266 A1
(43) Pub. Date: May 23, 2019

(54) PHASE RECOVERY DEVICE AND PHASE RECOVERY METHOD

(71) Applicant: MStar Semiconductor, Inc., Hsinchu Hsien (TW)

(72) Inventors: Jean-Louis DORNSTETTER, Choisel (FR); Yu-Jen CHOU, Hsinchu Hsien (TW); Yi-Ying LIAO, Hsinchu Hsien (TW); Ko-Yin LAI, Hsinchu Hsien (TW); Kai-Wen CHENG, Hsinchu Hsien (TW); Tai-Lai TUNG, Hsinchu Hsien (TW)

(21) Appl. No.: 16/056,706

(22) Filed: Aug. 7, 2018

(30) Foreign Application Priority Data
Nov. 23, 2017 (TW) 106140779
Mar. 1, 2018 (TW) 107106736

(51) Int. Cl. H04L 7/02

(52) U.S. Cl. CPC H04L 7/02

(57) ABSTRACT

A phase recovery device includes a phase recovery module and a residual phase recovery module. The phase recovery module performs a first-stage phase recovery on a received signal to generate a first phase recovered signal. The residual phase recovery module performs a second-stage phase recovery on the first phase-recovered signal to generate a second phase recovered signal.

This application claims the benefit of Taiwan application Serial No. 106140779, filed on Nov. 23, 2017, and Taiwan application Serial No. 107106736, file on Mar. 1, 2018, the subjects matter of which are incorporated herein by reference.

### BACKGROUND OF THE INVENTION

### Field of the Invention

The invention relates to a phase recovery device and a phase recovery method, and more particularly to a phase recovery device and a phase recovery method capable of accurately estimating a phase error.

### Description of the Related Art

In general, a phase recovery device at a receiving terminal of a digital communication system performs phase error detection (PED) on a received signal, and performs phase compensation on the received signal according to the estimated phase error to output a phase recovered signal, so as to reduce a symbol error rate (SER) or a bit error rate (BER) of the receiving terminal to improve system performance.

However, in the prior art, a phase recovery device performs only one-time phase recovery, and a phase recovered signal outputted therefrom still contains a residual phase error.

### SUMMARY OF THE INVENTION

Therefore, it is a primary object of the present invention to provide a phase recovery device and a phase recovery method capable of reducing a residual phase error to improve issues of the prior art.

A phase recovery device is disclosed according to an embodiment of the present invention. The phase recovery device includes: a phase recovery module, performing a first-stage phase recovery on a received signal to generate a first phase recovered signal; and a residual phase recovery module, performing a second-stage phase recovery on the first phase recovered signal to generate a second phase recovered signal.

A phase recovery method is further disclosed according to an embodiment of the present invention. The phase recovery method includes: performing a first-stage phase recovery on a received signal to generate a first phase recovered signal; and performing a second-stage phase recovery on the first phase recovered signal to generate a second phase recovered signal.

The above and other aspects of the invention will become better understood with regard to the following detailed description of the non-limiting embodiments. The following description is made with reference to the accompanying drawings.

### BRIEF DESCRIPTION OF THE DRAWINGS

FIG. 1 is a block diagram of a phase recovery device according to an embodiment of the present invention;

FIG. 2 is flowchart of a phase recovery method according to an embodiment of the present invention;

FIG. 3 is a block diagram of a phase recovery module according to an embodiment of the present invention;

FIG. 4 is a block diagram of a residual phase estimation module according to an embodiment of the present invention;

FIG. 5 is a flowchart of a phase recovery method according to an embodiment of the present invention;

FIG. 6 is a block diagram of a residual phase error estimator according to an embodiment of the present invention;

FIG. 7 is a block diagram of an averaging unit according to an embodiment of the present invention;

FIG. 8 is a block diagram of a characteristics unit according to an embodiment of the present invention; and

FIG. 9 is a block diagram of an estimating unit according to an embodiment of the present invention.

### DETAILED DESCRIPTION OF THE INVENTION

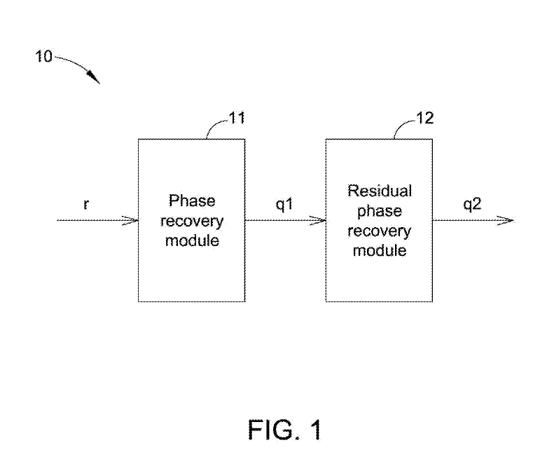

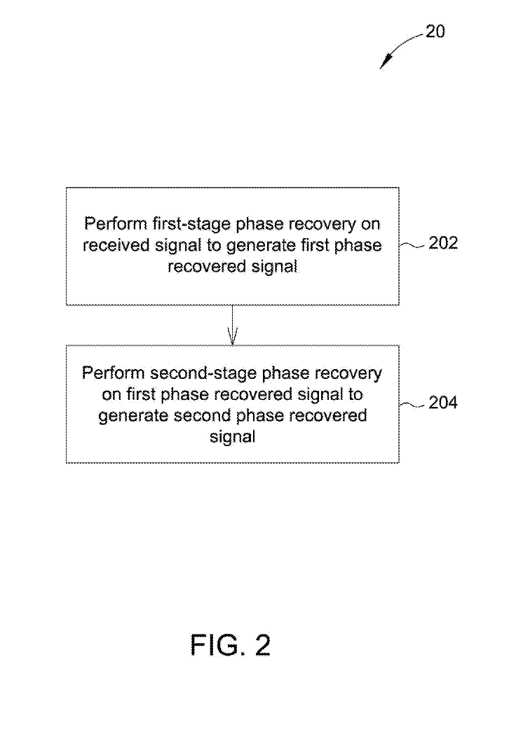

FIG. 1 shows a block diagram of a phase recovery device 10 according to an embodiment of the present invention. FIG. 2 shows a flowchart of a phase recovery method 20 according to an embodiment of the present invention. The phase recovery device 10 includes a phase recovery module 11 and a residual phase recovery module 12. The phase recovery module 11 performs a first-stage phase recovery on a received signal r to generate a first phase recovered signal q1 (step 202). The residual phase recovery module 12, coupled to the phase recovery module 11, performs a second-stage phase recovery on the first phase recovered signal q1 to generate a second phase recovered signal q2 (step 204), so as to perform phase recovery in regard to the residual phase error from the first-stage phase recovery.

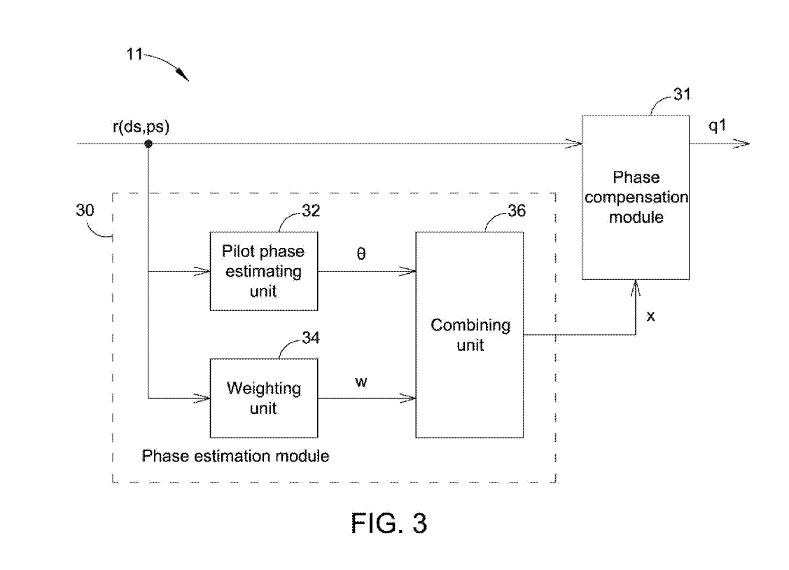

FIG. 3 shows a block diagram of the phase recovery module 11 according to an embodiment of the present invention. The phase recovery module 11 includes a phase estimation module 30 and a phase compensation module 31. The received signal r received by the phase recovery module 11 includes multiple data signals ds and multiple pilot signals ps. The phase estimation module 30 calculates multiple phase errors x based on the multiple pilot signals ps, and the phase compensation module 31 compensates the phases of the multiple data signals ds based on the multiple phase errors x.

In one embodiment, the multiple phase errors x are a linear combination of the multiple pilot phase errors θ. More specifically, again referring to FIG. 3, the phase estimation module 30 includes a pilot phase estimating unit 32, a weighting unit 34 and a combining unit 36. The pilot phase estimating unit 32 calculates multiple pilot phase errors θ based on the multiple pilot signals ps. The weighting unit 34 calculates multiple weightings w corresponding to the multiple pilot phase errors θ. The combining unit 36 calculates the multiple phase errors x corresponding to the multiple data signals ds according to the multiple pilot phase errors θ and the multiple weightings w. Other associated details are generally known to a person skilled in the art and are thus omitted herein.

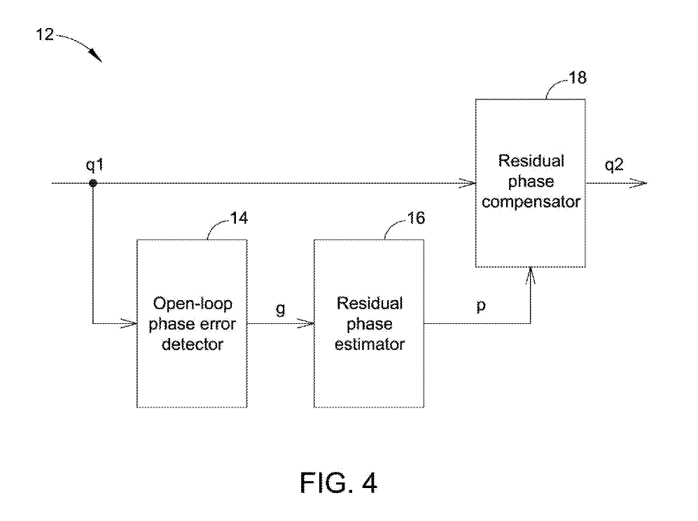

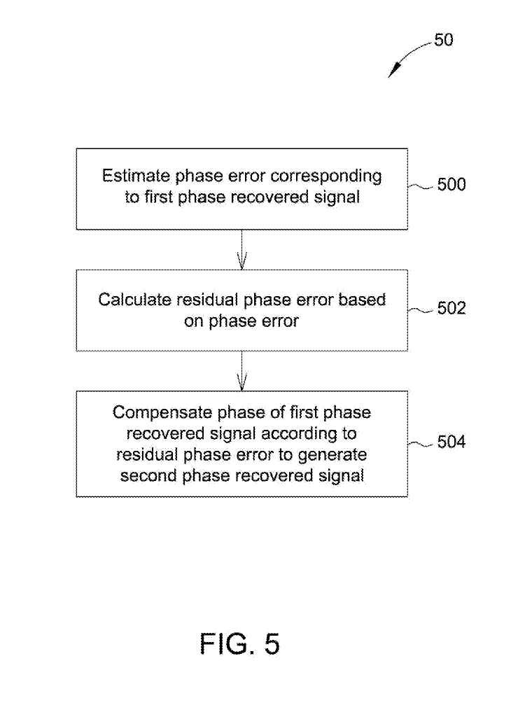

In one embodiment, the residual phase recovery device 12 may perform preliminary phase estimation on multiple first phase recovered signals q1 by using a phase error detector (PED) having a simple circuit structure or a low computation complexity, and then statistically calculate the results of the preliminary phase estimation to generate multiple residual phase errors. More specifically, FIG. 4 shows a block diagram of the residual phase recovery module 12 according to an embodiment of the present invention; FIG. 5 shows the flowchart of a residual phase recovery method 50 according to an embodiment of the present invention. In this embodiment, the residual phase recovery device 12 includes an open-loop PED 14, a residual phase estimator 16 and a residual phase compensator 18. The open-loop PED 14 estimates a phase error g of the first phase recovered signal q1 received from the phase recovery module 11 (step 500). Details of the open-loop PED 14 are generally known to a person skilled in the art, and are omitted herein. The residual phase estimator 16 calculates a residual phase error p based on the phase error g received from the open-loop PED 14 (step 502). The residual phase compensator 18, coupled to the phase recovery module 11 and the residual phase estimator 16, eventually compensates the phase of the first phase recovered signal q1 according to the residual phase error p to generate the second phase recovered signal q2 (step 504).

In one embodiment, the residual phase estimator 16 may perform principle component analysis (PCA) on the phase error g; that is, the residual phase estimator 16 calculates one or more eigenbases most significant in an eigen space associated with the phase error g and one or more corresponding eigenvalues, and constructs the residual phase error p according to the one or more most significant eigenbases and eigenvalues.

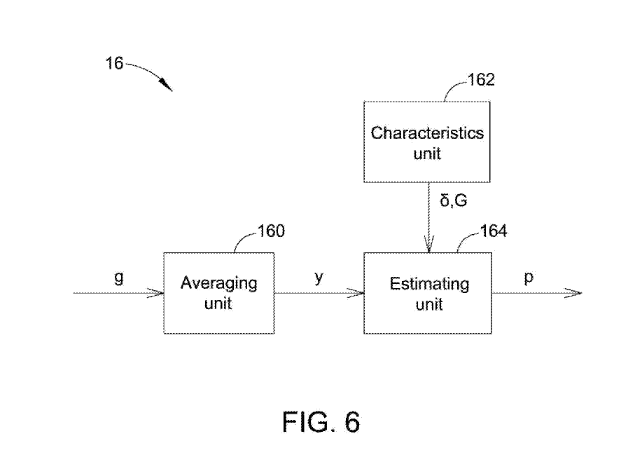

FIG. 6 shows a block diagram of the residual phase estimator 16 according to an embodiment of the present invention. The residual phase estimator 16 includes an averaging unit 160, a characteristics unit 162 and an estimating unit 164. The averaging unit 160 groups and performs an average calculation on the phase errors g to output multiple phase error averages y, which form a phase error average vector y. For example, the phase error g on the time axis includes N phase errors g₀ to g_{N-1}, wherein every M phase errors may be divided into one phase error group, the phase errors g₀ to g_{N-1} may be divided to K phase error groups g₀′ to g_{K-1}′ in total (i.e., N=K·M, where N, K and M are positive integers), and the k^{th} phase error group gₖ′ includes phase errors g_{kM} to g_{kM+M-1} (k=0, . . . , and K−1). The averaging unit 160 performs an average calculation on the phase error groups g₀′ to g_{K-1}′ to generate phase error averages y₀ to y_{K-1}, which form a phase error average vector y, i.e., y=[y₀ . . . y_{K-1}]^{T}. In one embodiment, for example but not limited to, N=1440, M=36 and K=40. In another embodiment, M=1, i.e., N=K, and the phase error averages y₀ to y_{K-1} outputted by the averaging unit 160 are the phase errors g₀ to g_{N-1}.

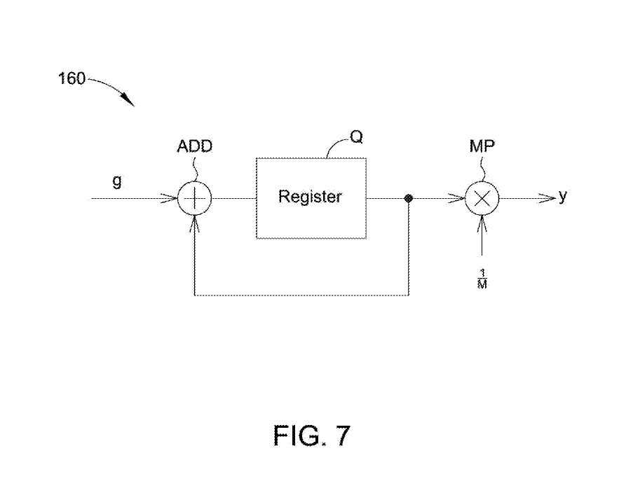

FIG. 7 shows a block diagram of the averaging unit 160 according to an embodiment of the present invention. The averaging unit 160 includes an adder ADD, a register Q and a multiplier MP. Taking the phase error group gₖ′ for instance, the adder ADD and the register Q perform an accumulation calculation on the phase errors g_{kM} to g_{kM+M-1} of the phase error group gₖ′ to obtain an accumulation result aₖ. The multiplier MP multiplies the accumulation result aₖ by 1/M, where M is the quantity of phase errors in the phase error group gₖ′, so as to obtain the phase error average yₖ corresponding to the phase error group gₖ′.

The characteristics unit 162 calculates at least one eigenbasis δ associated with the phase error average vector y and at least one eigengain G corresponding to the at least one eigenbasis δ, wherein the at least one eigengain G is each associated with at least one eigenvalue λ corresponding to the at least one eigenbasis δ. It should be noted that, the characteristics unit 162 implements a pre-processing phase (also referred to as a training phase or a learning phase) of the phase recovery method 20 to calculate the eigenbasis δ and the eigengain G in advance.

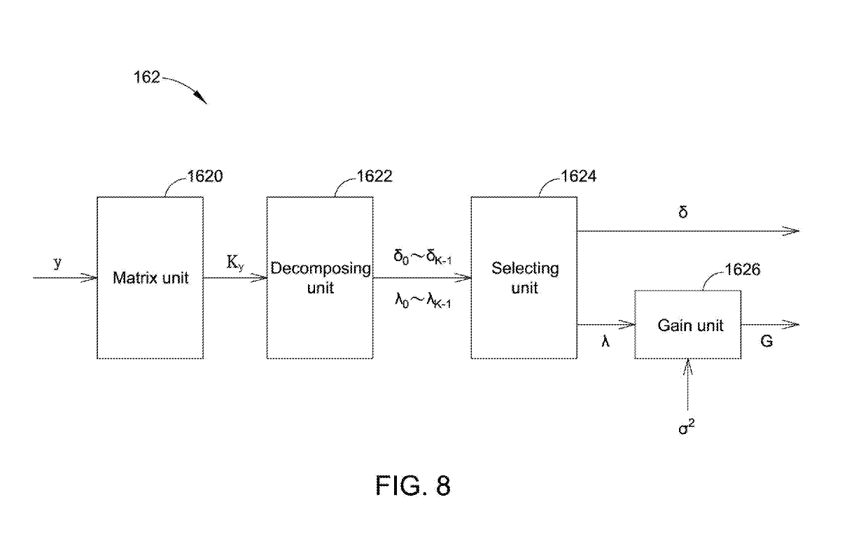

FIG. 8 shows a block diagram of the characteristics unit 162 according to an embodiment of the present invention. The characteristics unit 162 includes a matrix unit 1620, a decomposing unit 1622, a selecting unit 1624 and a gain unit 1626. The matrix unit 1620 collects the phase error average vectors y₀ to y_{L} of the pre-processing phase, and generates a covariance matrix

$${K}_{y} = \frac{1}{L} {\sum }_{j = 0}^{L - 1}$$

yⱼyⱼ^{H} according to the phase error average vectors y₀ to y_{L} of the pre-processing phase, where (·)^{H} represents conjugate transpose. The decomposing unit 1622 performs eigenvalue decomposition (EVD) or singular value decomposition (SVD) on the covariance matrix K_{y} to generate multiple eigenvectors δ₀ to δₖ₋₁ and multiple eigenvalues λ₀ to λ_{K-1} of the covariance matrix K_{y}. The selecting unit 1624 selects n eigenvalues from the multiple eigenvalues λ₀ to λ_{K-1}, and selects n eigenvectors from the multiple eigenvectors δ₀ to δ_{K-1} as the eigenbasis δ, wherein the n eigenvectors are the eigenvectors corresponding to the n eigenvalues. Preferably, the n eigenvalues selected by the selecting unit 1624 are n largest eigenvalues among the multiple eigenvalues λ₀ to λ_{K-1}. The quantity n of eigenvectors selected by the selecting unit 1624 may be adjusted according to actual conditions, where n is any positive integer between 1 and K. Taking n=2 for instance, the selecting unit 1624 selects two largest eigenvalues λ₀ and λ₁ among the multiple eigenvalues λ₀ to λ_{K-1}, and selects the eigenvectors δ₀ and δ₁ corresponding to the eigenvalues λ₀ and λ₁ as the eigenbasis δ. The gain unit 1626 calculates an eigengain Gₖ according to the eigenvalue λ_{K}. In one embodiment, Gₖ=λₖ/(λₖ+σ²), where σ is a constant associated with noise energy or an SNR, and may be adjusted according to actual conditions. When n=2, the gain unit 1626 outputs the eigengains G₀ and G₁ corresponding to the eigenvalues λ₀ and λ₁ as the eigengain G.

The estimating unit 164, coupled to the averaging unit 160 and the characteristics unit 162, calculates the residual phase error p according to the phase error average vector y, the at least one eigenbasis δ and the at least one eigengain G.

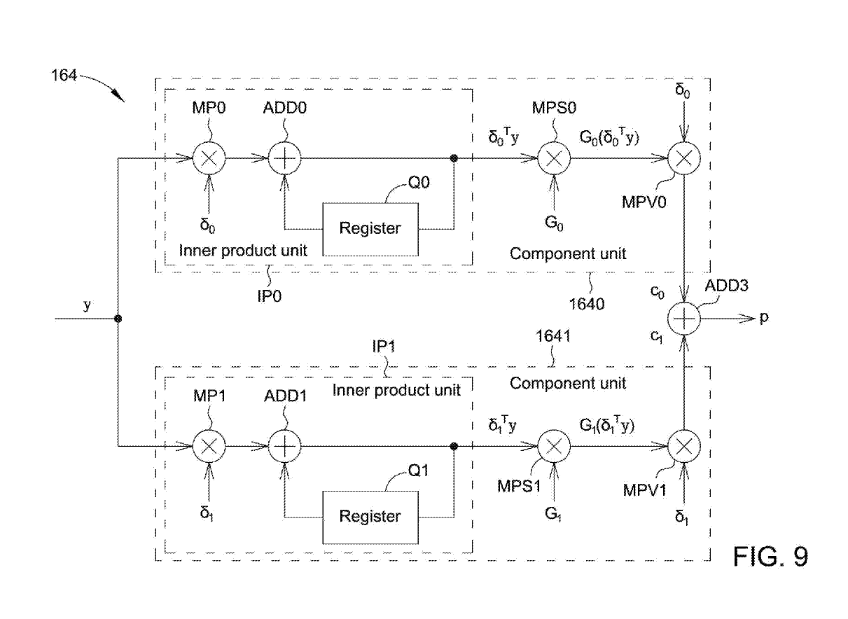

FIG. 9 shows a block diagram of the estimating unit 164 according to an embodiment of the present invention. The estimating unit 164 includes component unit 1640 and 1641 and a summing unit ADD3. The component unit 1640 calculates a component c₀ according to the phase error average vector y, the eigenbasis δ₀ and the eigengain G₀. Similarly, the component unit 1641 calculates a component c₁ according to the phase error average vector y, the eigenbasis δ₁ and the eigengain G₁. The summing unit ADD3 generates the residual phase error p according to the components c₀ and c₁. It should be noted that, the estimating unit 164 in FIG. 7 is an example in an embodiment where the quantity of eigenvectors selected by the selecting unit 1624 is n=2, and the present invention is not limited thereto. In other embodiments, the quantity of the component units in the estimating unit 164 corresponds to the quantity n of the eigenvectors selected by the selecting unit 1624.

In one embodiment, the component unit 1640 includes an inner product unit IP0, a scalar multiplier MPS0 and a vector multiplier MPV0. The inner product unit IP0 calculates an inner product δ₀^{T}y of the phase error average vector y and the eigenbasis δ₀. In one embodiment, the inner product unit IP0 includes a multiplier MP0, an adder ADD0 and a register Q0. The multiplier MP0 multiplies the multiple phase error averages y₀ to y_{K-1} in the phase error average vector y sequentially by multiple eigenbasis elements in the eigenbasis δ₀. The adder ADD0 and the register Q0 accumulate the sequential multiplication results of the multiple phase error averages y₀ to y_{K-1} and the multiple eigenbasis elements to generate the inner product δ₀^{T}y. The scalar multiplier MPS0 performs a multiplication calculation between a scalar and a scalar, namely, multiplying the inner product δ₀^{T}y by the eigengain G₀ to generate a multiplication result G₀(δ₀^{T}y). The vector multiplier MPV0 performs a multiplication calculation between a scalar and a vector, namely, multiplying the multiplication result G₀(δ₀^{T}y) by the eigenbasis δ₀ to generate the component c₀, which may be represented as c₀=G₀(δ₀^{T}y)·δ₀. The component unit 1641 has a circuit structure identical to that of the component unit 1640, and associated details are omitted herein. The component unit 1641 may output the component c₁, which may be represented as c₁=G₁(δ₁^{T}y)·δ₁. The summing unit ADD3 sums up the components c₀ and c₁ to output a vector c₀+c₁, which is the residual phase error p.

In conclusion, in the present invention, a residual phase recovery device is used to perform a second-stage phase recovery on a phase recovered signal outputted by a phase recovery device so as to reduce the residual phase error, thereby lowering an SER or BER and achieving enhanced system performance.

While the invention has been described by way of example and in terms of the embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A phase recovery device, comprising:
a phase recovery module, performing a first-stage phase recovery on a received signal to generate a first phase recovered signal; and
a residual phase recovery module, performing a second-stage phase recovery on the first phase recovered signal to generate a second phase recovered signal.

2. The phase recovery device according to claim 1, wherein the residual phase recovery module comprises:
an open-loop phase error detector (PED), coupled to the phase recovery module, estimating a phase error corresponding to the first phase recovered signal;
a residual phase estimator, coupled to the open-loop PED, calculating a residual phase error according to the phase error; and
a residual phase compensator, coupled to the phase recovery module and the residual phase estimator, compensating a phase of the first phase recovered signal according to the residual phase error.

3. The phase recovery device according to claim 2, wherein the residual phase estimator comprises:
an averaging unit, performing an average calculation on the phase error to generate a phase error average vector;
a characteristics unit, calculating at least one eigenbasis and at least one eigengain corresponding to the at least one eigenbasis according to the phase error average vector; and
an estimating unit, coupled to the averaging unit and the characteristics unit, calculating the residual phase error according to the phase error average vector, the at least one eigenbasis and the at least one eigengain.

4. The phase recovery device according to claim 3, wherein the averaging unit comprises an adder, a register and a multiplier, the adder and the register perform an accumulation calculation on the phase error, and the multiplier multiplies an accumulation result of the accumulation calculation by a reciprocal of a phase error accumulation quantity.

5. The phase recovery device according to claim 3, wherein the characteristics unit comprises:
a matrix unit, generating a covariance matrix corresponding to the phase error average vector;
a decomposing unit, performing a decomposition operation on the covariance matrix to generate a plurality of eigenvectors and a plurality of eigenvalues of the covariance matrix;
a selecting unit, selecting at least one eigenvalue from the plurality of eigenvalues, and selecting at least one eigenvector from the plurality of eigenvectors as the at least one eigenbasis, wherein the at least one eigenvector corresponds to the at least one eigenvalue; and
a gain unit, calculating the at least eigengain according to the at least one eigenvalue.

6. The phase recovery device according to claim 3, wherein the estimating unit comprises:
at least one component unit, calculating at least one component according to the phase error average vector, the at least one eigenbasis and the at least one eigengain; and
a summing unit, generating the residual phase error according to the at least one component.

7. The phase recovery device according to claim 6, wherein the at least one component unit comprises:
an inner product unit, calculating an inner product of the phase error average vector and the at least one eigenbasis;
a scalar multiplier, multiplying the inner product by the at least one eigengain to generate a multiplication result; and
a vector multiplier, multiplying the multiplication result by the at least one eigenbasis to generate the at least one component.

8. The phase recovery device according to claim 7, wherein the inner product unit comprises a multiplier, an adder and a register, the multiplier multiplies a plurality of phase error averages in the phase error average vector sequentially by a plurality of eigenbasis elements in the at least one eigenbasis to generate a plurality of multiplication results, and the adder and the register perform an accumulation calculation on the plurality of multiplication results to generate the inner product.

9. The phase recovery device according to claim 1, wherein the received signal comprises a plurality of data signals and a plurality of pilot signals, and the phase recovery module comprises:
a phase estimation module, comprising:
a pilot phase estimating unit, calculating a plurality of pilot phase errors based on the plurality of pilot signals;
a weighting unit, calculating a plurality of weightings corresponding to the plurality of pilot phase errors; and
a combining unit, calculating a plurality of phase errors corresponding to the plurality of data signals according to the plurality of pilot phase errors and the plurality of weightings, wherein the plurality of phase errors are a linear combinations of the plurality of pilot phase errors; and
a phase compensation module, compensating phases of the plurality of data signals according to the plurality of phase errors.

10. A phase recovery method, comprising:
performing a first-stage phase recovery on a received signal to generate a first phase recovered signal; and
performing a second-stage phase recovery on the first phase recovered signal to generate a second phase recovered signal.

11. The phase recovery method according to claim 10, wherein the step of performing the second-stage phase recovery on the first phase recovered signal to generate the second phase recovered signal comprises:
estimating a phase error corresponding to the first phase recovered signal;
calculating a residual phase error according to the phase error; and
compensating a phase of the first phase recovered signal according to the residual phase error.

12. The phase recovery method according to claim 11, wherein the step of calculating the residual phase error according to the phase error comprises:
performing an average calculation on the phase error to generate a phase error average vector;
calculating at least one eigenbasis and at least one eigengain corresponding to the at least one eigenbasis according to the phase error average vector; and
calculating the residual phase error according to the phase error average vector, the at least one eigenbasis and the at least one eigengain.

13. The phase recovery method according to claim 12, wherein the step of calculating the at least one eigenbasis and the at least one eigengain corresponding to the at least one eigenbasis comprises:
generating a covariance matrix corresponding to the phase error average vector;
performing a decomposition operation on the covariance matrix to generate a plurality of eigenvectors and a plurality of eigenvalues of the covariance matrix;
selecting at least one eigenvalue from the plurality of eigenvalues, and selecting at least one eigenvector from the plurality of eigenvectors as the at least one eigenbasis, wherein the at least one eigenvector corresponds to the at least one eigenvalue; and
calculating the at least eigengain according to the at least one eigenvalue.

14. The phase recovery method according to claim 12, wherein the step of calculating the residual phase error according to the phase error average vector, the at least one eigenbasis and the at least one eigengain comprises:
calculating at least one component according to the phase error average vector, the at least one eigenbasis and the at least one eigengain; and
generating the residual phase error according to the at least one component.

15. The phase recovery method according to claim 14, wherein the step of calculating the at least one component comprises:
calculating an inner product of the phase error average vector and the at least one eigenbasis;
multiplying the inner product by the at least one eigengain to generate a multiplication result; and
multiplying the multiplication result by the at least one eigenbasis to generate the at least one component.
